(19) United States
(12) Patent Application Publication
(10) Pub. No.: US 2018/0348789 A1
(43) Pub. Date: Dec. 6, 2018

(54) METHOD FOR OPTIMIZING A DIGITAL MAP FOR AN AUTOMATED VEHICLE

(71) Applicant: Robert Bosch GmbH, Stuttgart (DE)

(72) Inventors: Peter Christian Abeling, Hannover (DE); Daniel Zaum, Sarstedt (DE); Stefan Werder, Hannover (DE)

(21) Appl. No.: 15/990,206

(22) Filed: May 25, 2018

(30) Foreign Application Priority Data
Jun. 1, 2017 (DE) 102017209283.1

(51) Int. Cl. G05D 1/02; G01C 21/34; G01C 21/36

(52) U.S. Cl. CPC G05D 1/0274; G05D 1/0212; G05D 1/0088; G01C 21/367; G01C 21/3476

(57) ABSTRACT

A method for optimizing a digital map for an automated vehicle includes selecting an area of the digital map, ascertaining a localization quality provided with the aid of the digital map in the selected area based on usage data of the digital map, and providing at least one suggestion for optimizing landmarks of the digital map with respect to an electronic memory requirement of the digital map.

### CROSS REFERENCE

The present application claims the benefit under 35 U.S.C. § 119 of German Patent Application No. DE 102017209283.1 filed on Jun. 1, 2017, which is expressly incorporated herein by reference in its entirety.

### FIELD

The present invention relates to a method for optimizing a digital map for an automated vehicle. The present invention furthermore relates to a device for optimizing a digital map for an automated vehicle. The present invention furthermore relates to a computer program product.

### BACKGROUND INFORMATION

Methods and systems for mapping traveled roads with the aid of sensors (for example, cameras, radar sensors, ultrasonic sensors, etc.) installed in the vehicles are available. In addition to the described sensors, these systems generally also include a radio interface (for example, implemented via a connectivity unit) for transmitting the measured sensor data to a server. In this way, entire vehicle fleets may map their collective surroundings with the aid of the vehicle sensors by transmitting their sensor data, for example, to a server. The transmission of such so-called “fleet mapping data” is available.

The sensor data are collected on the server, and a digital map for the relevant road segment is generated from the data from multiple trips. The digital maps (also referred to as HAD maps, AD maps or HD maps) ascertained in this way are used, among other things, to allow the localization of automatically driving vehicles in the digital map (for example, for a very precise ascertainment of their positions). So-called landmarks are used in this, which are listed in the digital map with their exact geographical positions.

Typical landmarks are, for example, roadway markings, road signs, guard rails, etc. When an automatically driving vehicle detects one or multiple landmark(s) with the aid of the vehicle sensor system and is able to unambiguously locate these landmarks in the digital map, a very precise relative position of the vehicle relative to the landmark on the digital map may be derived. A density and quality of the landmarks thus considerably influences a quality of the local localization with respect to the accuracy of the ascertained position. In reality, route sections exist in which many and very useful landmarks are present, as well as sections in which a poor coverage of landmarks exists, so that this may in some circumstances result in a poor quality of the localization.

Methods for localizing vehicles with the aid of landmarks have been extensively explored are also available. For example, there is a national German initiative for the creation of special landmarks, in which the specific landmark signs are mounted with equidistant positioning for automated driving.

PCT Application No. WO 2015/156821 A1 describes a vehicle localization system including a first localization system, a second localization system, and a control unit. The first localization system is designed to localize the vehicle using first data, and the second localization system is designed to localize the vehicle using second data. The control unit is designed to switch between the first and the second localization system if the first data are less than a predefined extent.

### SUMMARY

It is an object of the present invention to provide a system for optimizing a digital map for a vehicle.

According to a first aspect of the present invention, the object may be achieved by an example method for optimizing a digital map for an automated vehicle, including the steps:
selecting an area of the digital map;
ascertaining a localization quality provided with the aid of the digital map in the selected area based on useful data of the digital map; and
providing at least one suggestion for optimizing landmarks of the digital map with respect to an electronic memory requirement of the digital map.

In this way, a method is created with the aid of which a digital map which is optimized with respect to the memory requirement is provided, due to the provision of at least one suggestion for optimizing landmarks. As a result, it is thus advantageously achieved that a memory requirement of the digital map is decreased since, for example, fewer landmarks have to be stored therein. Advantageously, electronic memory in the motor vehicle, which in general is always expensive and scarce, may thus be utilized as little as possible.

According to a second aspect of the present invention, the object may be achieved by a device for optimizing a digital map for an automated vehicle, including:
a selection element for selecting an area of the digital map;
an ascertainment element for ascertaining a localization quality in the selected area of the digital map based on usage data; and
an optimization element for providing at least one suggestion for optimizing landmarks of the digital map with respect to an electronic memory requirement of the digital map.

Advantageous refinements of the example method are described herein.

One advantageous refinement of the example method according to the present invention provides that the at least one suggestion for optimizing the landmarks includes a removal of a landmark which is not required from the digital map. In this way, the electronic memory requirement for the digital map may be reduced easily and effectively.

One further advantageous refinement of the example method provides that the at least one suggestion for optimizing the landmarks includes an exchange or a replacement of at least one unfavorable landmark in terms of the memory requirement with a more favorable landmark in terms of the memory requirement in the digital map. In this way, an alternative or additional suggestion for optimizing the electronic memory requirement of the digital map is provided.

One further advantageous refinement of the example method provides that a new landmark is inserted into the digital map between existing landmarks. In this way, a specific manner of adding a landmark for optimizing the digital map is provided, whereby a locating accuracy with the aid of the digital map may be improved.

One further advantageous refinement of the example method provides that a landmark of another type is inserted into the digital map between two landmarks of the same type. In this way as well, a specific manner of adding a landmark for optimizing the digital map is provided, whereby a locating accuracy with the aid of the digital map may be improved. For example, landmarks may be designed as visually easily detectable patterns and/or as reflectors for radar signals and/or as a combination of the described elements and/or as simple and inexpensive landmarks as opposed to expensive landmarks etc.

One further advantageous refinement of the example method provides that the at least one suggestion for optimizing the landmarks is output on a display unit. In this way, it is advantageously made possible that the at least one suggestion for optimizing the landmark is rendered visible to a user.

One further advantageous refinement of the example method provides that a simulation method is used for ascertaining the localization quality. In this way, proven computational simulation methods, which are known per se, for optimizing the digital map may be used, which above all are carried out in a computer-assisted manner.

One further advantageous refinement of the example method provides that the ascertainment of the localization quality is checked based on threshold values. In this way, a decision-making threshold is provided, based on which it is decided as to whether at least one suggestion for optimizing the landmarks of the digital map is provided.

One further advantageous refinement of the example method provides that the at least one suggested optimization regarding landmarks is implemented in the surroundings, the localization quality provided with the aid of the digital map being verified based on user data. In this way, a “transfer” of the method into reality is carried out, a localization quality of the modified digital map being verified with the aid of user data. In this way, an optimization quality of the digital map may be further improved.

One further advantageous refinement of the example method provides that an optimization potential of the digital map is checked independently of the ascertained localization quality. In this way, it is checked independently of the ascertained localization quality as to whether an optimization potential exists for the digital map. Advantageously, the digital map may thus be even further optimized under extended aspects.

The present invention is described in greater detail hereafter with further features and advantages based on several figures.

Described method features result similarly from correspondingly described device features, and vice versa. This means in particular that features, technical advantages and statements regarding the method result similarly from corresponding statements, features and advantages regarding the device for optimizing a digital map for an automated vehicle, and vice versa.

### BRIEF DESCRIPTION OF THE DRAWINGS

FIG. 1 shows a schematic representation of a mode of action of the example method according to the present invention.

FIG. 2 shows one advantageous refinement of the provided method.

FIG. 3 shows a block diagram of a provided device for carrying out the provided method.

### DETAILED DESCRIPTION OF EXAMPLE EMBODIMENTS

Hereafter, an automated motor vehicle shall synonymously also be understood to mean a semi-automated motor vehicle, an autonomous motor vehicle, and a semi-autonomous motor vehicle.

The present invention in particular includes optimizing a digital map for an automated vehicle, where, in particular, an electronic memory requirement for the described digital map is to be kept preferably low.

For this purpose, it is provided to initially evaluate a defined area of a digital map (highly automated driving (HAD) map) as to whether and how an improvement in the landmark coverage, and thus the positioning accuracy of the localization, is achievable. For this purpose, properties (for example, number, positions, type, visibility, age, etc.) of existing landmarks of the area are used to evaluate to what extent an omission or addition of the landmarks has a favorable influence on an electronic memory requirement for the digital map.

Resulting from this, an improvement in the localization quality with the aid of the digital map may also be achieved with the aid of a structural change of the landmarks or a new installation of additional landmarks. With respect to the structural changes of existing landmarks, for example, a demolition, a relocation, a cleaning and the elimination of obstacles which have a negative impact on the visibility of the landmarks, etc., may be considered.

The evaluation thus takes place in two steps:
1. Evaluation of the presumable localization quality of an automated vehicle in a map segment as a function of the landmarks which are present in the map and individually usable for the automated vehicle (as a function of the sensor configuration of the vehicle).
2. Evaluation as to which change of the landmarks of the digital map has the greatest positive influence on the above-mentioned localization quality.

The result of the method provided here supplies at least one suggestion, or also multiple suggestions, for adding/omitting landmarks in the digital map, with the localization quality ascertained with the aid of simulation at least remaining the same.

In this way, an analysis of the landmarks of a segment of the digital map with respect to the suitability for localization is used to provide a change of landmarks of the digital map with the aid of which the positioning accuracy is at least maintained, or even improved. This takes place with respect to a preferably minimal complexity and/or minimal costs, which is achievable above all by a reduced electronic memory requirement for the digital map.

The provided method results in multiple advantages:

a) An expansion of landmarks in a certain area for improving the localization is already known. With the provided method, however, it is advantageously possible to achieve this with minimal complexity/costs by deliberately searching for a simple implementation in the digital map (for example, preferably few new landmarks, ideally relocating existing landmarks, providing suitable types of landmarks, suitably mixing types of landmarks, etc.).

b) The provided method may be deliberately applied to an area of the digital map to be analyzed. This may be an area, for example, in which the localization for automated vehicles is often inadequate or fails, which is detected with the aid of useful data of the vehicles.

c) The method advantageously automates and accelerates a process of landmark analysis.

An input variable of the provided method is a defined area of a digital map, which preferably depicts a regional or local section of a landscape in which landmarks are stored for localization.

The objectives of the provided method are in particular:
1. To analyze a segment of the digital map with respect to the suitability of the landmarks for localization, and
2. to propose changes to landmarks of the digital map with which the accuracy of the localization may be improved, or at least maintained, compared to the actual state. Minimal complexity and/or minimal costs are sought, in particular in the form of a reduced electronic memory requirement for the digital map.

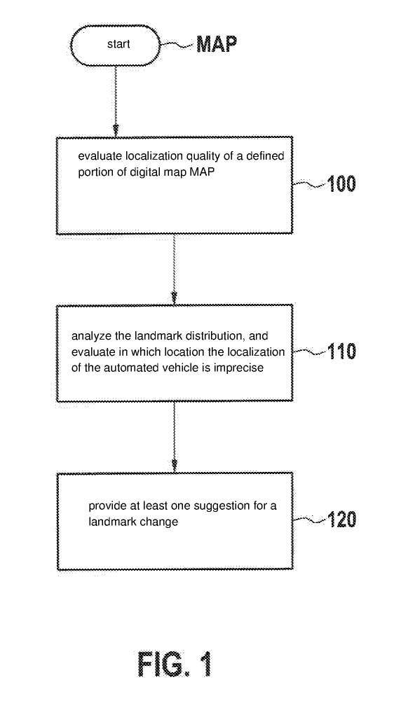

FIG. 1 shows a drastically simplified sequence of one specific embodiment of the provided method.

In a step 100, the localization quality of a defined portion of digital map MAP is evaluated. Key quality figures are ascertained, which indicate the accuracy and robustness with which the localization with the aid of selected digital map MAP functions in the defined portion. This may be achieved, for example, with the aid of simulation or with the aid of an actually carried out trip. For each automated vehicle, individual vehicle features or vehicle features relevant per vehicle type, such as the equipped sensor configuration, are utilized.

In a step 110, an analysis of the landmark distribution is carried out, in this step treated digital map MAP being analyzed with respect to the landmark distribution, i.e., it is analyzed in greater detail as to how the localization quality ascertained in step 100 is achieved. All relevant properties of the landmarks are considered here, if available, for example, number, position, suitability for certain sensors, safety, visibility, age of the landmarks, etc.

In addition, the results of the quality evaluation from step 100 are used to evaluate in what location the localization of the automated vehicle with the aid of the digital map MAP is particularly imprecise. The results may be used for subsequent step 120.

In a step 120, at least one suggestion for a landmark change is provided, one or multiple suggestion(s) for a change of the landmarks of digital map MAP being ascertained with the aid of an optimization method. This may include, for example, removing the landmarks from digital map MAP, changing the landmarks of digital map MAP, and replacing a less favorable landmark in terms of the memory requirement with a more favorable landmark in terms of the memory requirement in digital map MAP. As a result, it is thus advantageously achieved that digital map MAP may be implemented with preferably low electronic memory requirement, however at least a consistent localization accuracy being achieved with the aid of digital map MAP. The coordination of this equalization or trade-off may preferably be parameterized.

In a further, optional step, which is not shown, it is possible to output (for example, visually) the at least one suggestion for optimizing digital map MAP at a display unit, whereby the provided optimization method regarding landmarks becomes apparent for the user.

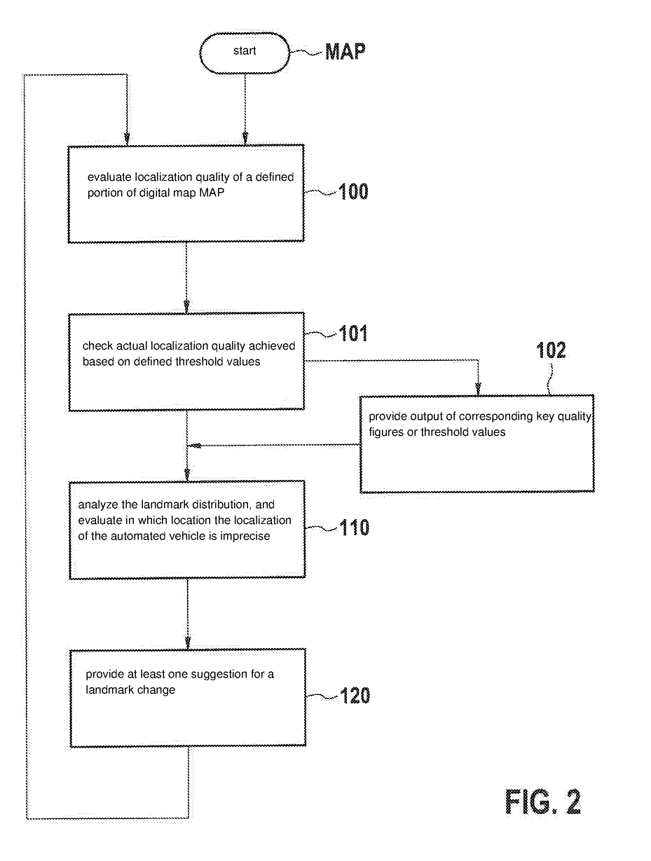

FIG. 2 shows a schematic sequence of one advantageous refinement of the provided method, in this case a cyclical and interactive procedure being provided.

Based on the ascertained suggestion, a simulation of the localization is carried out based on localization data ascertained with the aid of sensors.

Step 100 is identical to the specific embodiment of the method from FIG. 1.

The iterative procedure for ascertaining an optimization of digital map MAP provides a further step 101 in which the actual localization quality achieved with the aid of digital map MAP is checked based on defined threshold values. In an optional step 102, an output of corresponding key quality figures or threshold values may be provided, the method being ended after step 102 (not shown) in a case that a drop below a threshold value occurs.

Steps 110 and 120 correspond to those from FIG. 1, after step 120 a transfer of the method into practice now being carried out, the provided optimization being implemented in the form of at least one change of landmarks (for example, distance, addition, relocation, mixing, etc.) in the real surroundings.

With cyclically run-through steps 100 through 120, an iterative process is created, in which the impact of the changed landmarks on a localization quality in practice is ascertained using automated vehicles and with the aid of which sensor data are recorded. The ascertained sensor data are introduced into the method in step 100, and it is checked based on genuine usage data as to whether an improved localization quality with the aid of digital map MAP is actually achievable.

It is also possible for the case to occur that no improvement in the localization quality with the aid of digital map MAP is achieved with the aid of a change of landmarks, so that in this case it is suggested thereafter to maintain the actual state (“avoidance of overoptimization”).

In one variant of the method not shown in the figures, it is also possible to check optimization potential of digital map MAP independently of an ascertained localization quality.

With the aid of provided optimized digital map MAP, an improved operation of the automated vehicle is possible. In particular, due to the optimized electronic memory requirement of digital map MAP, a computing complexity within the automated vehicle for operating the automated vehicle may be optimized, resulting in an efficient operation of the automated vehicle as a function of digital map MAP.

It shall be understood that the number of steps for achieving the functionality of the provided method is arbitrary, so that the provided method is also achievable with a lower or higher number of steps than the number of steps described above.

Advantageously, the provided method may be implemented as software using program code means for running on an electronic processor device, whereby an easy modifiability and adaptability of the method is supported.

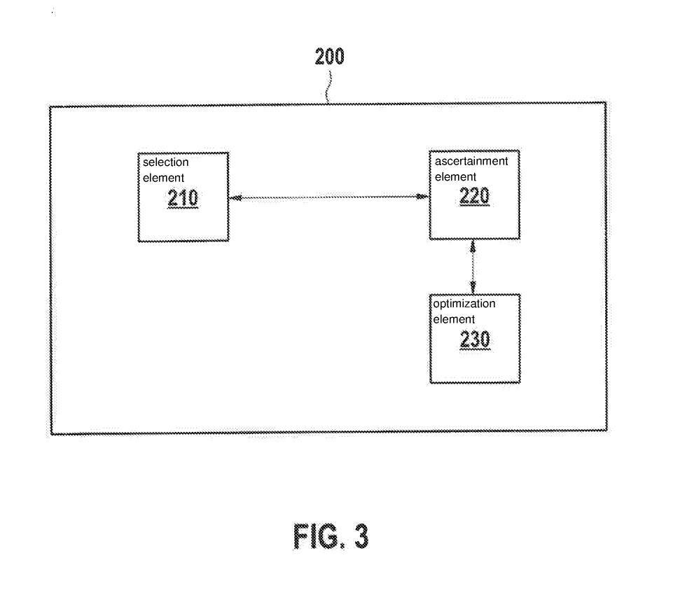

FIG. 3 shows a simplified block diagram of a device 200 for optimizing a digital map MAP for an automated vehicle (not shown).

In device 200, a selection element 210 for selecting an area of digital map MAP is apparent, which is provided with an ascertainment element 220 for ascertaining a localization quality in the selected area of digital map MAP based on useful data. Ascertainment element 220 is functionally connected to an optimization element 230, which provides at least one suggestion for optimizing landmarks of digital map MAP.

Advantageously, provided device 200, including the described elements, may be implemented as software including program code means for running on an electronic processor device, whereby an easy modifiability and adaptability of the device is supported.

Those skilled in the art will suitably modify the features of the present invention and/or combine them with each other, without departing from the core of the present invention.

What is claimed is:

1. A method for optimizing a digital map for an automated vehicle, comprising:
selecting an area of the digital map;
ascertaining a localization quality provided with the aid of the digital map in the selected area based on usage data of the digital map; and
providing at least one suggestion for optimizing landmarks of the digital map with respect to an electronic memory requirement of the digital map.

2. The method as recited in claim 1, wherein the at least one suggestion for optimizing the landmarks includes a removal of a landmark which is not required from the digital map.

3. The method as recited in claim 1, wherein the at least one suggestion for optimizing the landmarks includes an exchange or a replacement in the digital map of at least one unfavorable landmark in terms of the memory requirement with a more favorable landmark in terms of the memory requirement.

4. The method as recited in claim 3, wherein a new landmark is inserted into the digital map between existing landmarks.

5. The method as recited in claim 3, wherein a landmark of another type is inserted into the digital map between two landmarks of the same type.

6. The method as recited in claim 1, wherein the at least one suggestion for optimizing the landmarks is output at a display unit.

7. The method as recited in claim 1, wherein a simulation method is used for ascertaining the localization quality.

8. The method as recited in claim 1, wherein the ascertainment of the localization quality is checked based on threshold values.

9. The method as recited in claim 3, wherein the at least one suggestion for optimizing the landmarks is implemented in the surroundings, the localization quality provided with the aid of the digital map being verified based on user data.

10. The method as recited in claim 1, wherein an optimization potential of the digital map is checked independently of the ascertained localization quality.

11. A device for optimizing a digital map for an automated vehicle, comprising:
a selection element for selecting an area of the digital map;
an ascertainment element for ascertaining a localization quality in the selected area of the digital map based on useful data; and
an optimization element for providing at least one suggestion for optimizing landmarks of the digital map with respect to an electronic memory requirement of the digital map.

12. A non-transitory computer-readable data carrier on which is stored a computer program including program code for optimizing a digital map for an automated vehicle, the computer program, when executed by a processor, causing the processor to perform:
selecting an area of the digital map;
ascertaining a localization quality provided with the aid of the digital map in the selected area based on usage data of the digital map; and
providing at least one suggestion for optimizing landmarks of the digital map with respect to an electronic memory requirement of the digital map.
